(19) United States
(12) Patent Application Publication
(10) Pub. No.: US 2025/0113374 A1
(43) Pub. Date: Apr. 3, 2025

(54) TECHNIQUES FOR RESUMING SIDELINK TRANSMISSIONS WITHIN A SHARED CHANNEL OCCUPANCY TIME

(71) Applicant: QUALCOMM Incorporated, San Diego, CA (US)

(72) Inventors: Giovanni CHISCI, San Diego, CA (US); Chih-Hao LIU, San Diego, CA (US); Jing SUN, San Diego, CA (US); Jae Ho RYU, San Diego, CA (US); Xiaoxia ZHANG, San Diego, CA (US)

(21) Appl. No.: 18/790,221

(22) Filed: Jul. 31, 2024

Related U.S. Application Data
(60) Provisional application No. 63/586,996, filed on Sep. 29, 2023.

(51) Int. Cl. H04W 74/00; H04W 72/25

(52) U.S. Cl. CPC H04W 74/002; H04W 72/25

(57) ABSTRACT

Methods, systems, and devices for wireless communications are described. A user equipment (UE) performs a first channel access procedure for accessing a channel occupancy time (COT) within the sidelink channel. The UE transmits a second-stage sidelink control information (SCI) message (SCI-2) including COT sharing information (COT-SI) for sharing the COT with other devices, and transmits a first sidelink message within a first portion of the COT. The UE identifies a second sidelink message that is expected to be received within a second portion of the COT, and performs a second channel access procedure for accessing the COT after identifying the second sidelink message based on the second sidelink message being expected within a set of resources reserved for the second sidelink message. Subsequently, the UE transmits a third sidelink message within a third portion of the COT based on a completion of the second channel access procedure.

### CROSS REFERENCE

The present application for patent claims the benefit of U.S. Provisional Patent Application No. 63/586,996 by CHISCI et al., entitled “TECHNIQUES FOR RESUMING SIDELINK TRANSMISSIONS WITHIN A SHARED CHANNEL OCCUPANCY TIME,” filed Sep. 29, 2023, assigned to the assignee hereof, and expressly incorporated by reference herein.

### FIELD OF TECHNOLOGY

The following relates to wireless communications, including techniques for resuming sidelink transmissions within a shared channel occupancy time (COT).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In the context of unlicensed spectrum, wireless devices may be configured to preform channel access procedures to gain access to channel occupancy times (COTs) within which the devices may perform communications. In some cases, wireless devices may be able to share access to COTs.

### SUMMARY

A method for wireless communications by a first user equipment (UE) is described. The method may include monitoring a sidelink channel as part of a first channel access procedure for accessing a channel occupancy time (COT) within the sidelink channel, transmitting a second-stage sidelink control information (SCI) message including COT sharing information (COT-SI) for sharing the COT with one or more additional UEs, transmitting a first sidelink message within a first portion of the COT, identifying a second sidelink message that is expected to be received within a second portion of the COT based on transmitting the second-stage SCI message, performing a second channel access procedure for accessing the COT after identifying the second sidelink message based on the second sidelink message being expected within a set of resources of the sidelink channel reserved for the second sidelink message, and transmitting a third sidelink message within a third portion of the COT based on a completion of the second channel access procedure.

A first UE for wireless communications is described. The first UE may include one or more memories storing processor executable code, and one or more processors coupled with the one or more memories. The one or more processors may individually or collectively operable to execute the code to cause the first UE to monitor a sidelink channel as part of a first channel access procedure for accessing a COT within the sidelink channel, transmit a second-stage SCI message including COT-SI for sharing the COT with one or more additional UEs, transmit a first sidelink message within a first portion of the COT, identify a second sidelink message that is expected to be received within a second portion of the COT based on transmitting the second-stage SCI message, perform a second channel access procedure for accessing the COT after identifying the second sidelink message based on the second sidelink message being expected within a set of resources of the sidelink channel reserved for the second sidelink message, and transmit a third sidelink message within a third portion of the COT based on a completion of the second channel access procedure.

Another first UE for wireless communications is described. The first UE may include means for monitoring a sidelink channel as part of a first channel access procedure for accessing a COT within the sidelink channel, means for transmitting a second-stage SCI message including COT-SI for sharing the COT with one or more additional UEs, means for transmitting a first sidelink message within a first portion of the COT, means for identifying a second sidelink message that is expected to be received within a second portion of the COT based on transmitting the second-stage SCI message, means for performing a second channel access procedure for accessing the COT after identifying the second sidelink message based on the second sidelink message being expected within a set of resources of the sidelink channel reserved for the second sidelink message, and means for transmitting a third sidelink message within a third portion of the COT based on a completion of the second channel access procedure.

A non-transitory computer-readable medium storing code for wireless communications is described. The code may include instructions executable by a processor to monitor a sidelink channel as part of a first channel access procedure for accessing a COT within the sidelink channel, transmit a second-stage SCI message including COT-SI for sharing the COT with one or more additional UEs, transmit a first sidelink message within a first portion of the COT, identify a second sidelink message that is expected to be received within a second portion of the COT based on transmitting the second-stage SCI message, perform a second channel access procedure for accessing the COT after identifying the second sidelink message based on the second sidelink message being expected within a set of resources of the sidelink channel reserved for the second sidelink message, and transmit a third sidelink message within a third portion of the COT based on a completion of the second channel access procedure.

Some examples of the method, first UEs, and non-transitory computer-readable medium described herein may further include operations, features, means, or instructions for transmitting a fourth sidelink message to a second UE, where the set of resources may be reserved for a feedback message responsive to the fourth sidelink message, the second sidelink message including the feedback message, and where the second channel access procedure may be performed after identifying the second sidelink message based on the feedback message being expected within the set of resources reserved for the feedback message.

In some examples of the method, first UEs, and non-transitory computer-readable medium described herein, the second-stage SCI message including the COT-SI may be transmitted to the second UE and the second channel access procedure may be performed after identifying the second sidelink message based on transmitting the COT-SI to the second UE and identifying the feedback message from the second UE.

Some examples of the method, first UEs, and non-transitory computer-readable medium described herein may further include operations, features, means, or instructions for identifying a satisfaction of a matching identifier criterion based on a first identifier within the fourth sidelink message matching a second identifier within the COT-SI, where the second channel access procedure may be performed after identifying the second sidelink message based on the satisfaction of the matching identifier criterion.

In some examples of the method, first UEs, and non-transitory computer-readable medium described herein, the first identifier and the second identifier include logical identifiers associated with the second-stage SCI message.

Some examples of the method, first UEs, and non-transitory computer-readable medium described herein may further include operations, features, means, or instructions for receiving a fourth sidelink message from a second UE, where the fourth sidelink message reserves the set of resources for the second sidelink message, and where the second channel access procedure may be performed after identifying the second sidelink message based on the second sidelink message being expected within the set of resources reserved by the fourth sidelink message.

In some examples of the method, first UEs, and non-transitory computer-readable medium described herein, the fourth sidelink message includes a first-stage SCI message.

In some examples of the method, first UEs, and non-transitory computer-readable medium described herein, the second-stage SCI message including the COT-SI may be transmitted to the second UE and the second channel access procedure may be performed after identifying the second sidelink message based on transmitting the COT-SI to the second UE and identifying the second sidelink message from the second UE.

Some examples of the method, first UEs, and non-transitory computer-readable medium described herein may further include operations, features, means, or instructions for identifying a satisfaction of a matching identifier criterion based on a first identifier within the fourth sidelink message matching a second identifier within the COT-SI, where the second channel access procedure may be performed after identifying the second sidelink message based on the satisfaction of the matching identifier criterion.

In some examples of the method, first UEs, and non-transitory computer-readable medium described herein, the first identifier and the second identifier include logical identifiers associated with the second-stage SCI message.

In some examples of the method, first UEs, and non-transitory computer-readable medium described herein, the second sidelink message includes a sidelink shared channel message and a sidelink control channel message.

Some examples of the method, first UEs, and non-transitory computer-readable medium described herein may further include operations, features, means, or instructions for refraining from transmitting sidelink messages within the second portion of the COT based on the set of resources of the sidelink channel being reserved for the second sidelink message within the second portion of the COT, where the second sidelink message may be received based on refraining from transmitting sidelink messages within the second portion of the COT.

Some examples of the method, first UEs, and non-transitory computer-readable medium described herein may further include operations, features, means, or instructions for refraining from processing information included within the second-stage SCI message based on the second sidelink message being received within the set of resources reserved for the second sidelink message.

In some examples of the method, first UEs, and non-transitory computer-readable medium described herein, the first channel access procedure includes a Type 1 channel access procedure and the second channel access procedure includes a Type 2 channel access

### BRIEF DESCRIPTION OF THE DRAWINGS

FIG. 1 shows an example of a wireless communications system that supports techniques for resuming sidelink transmissions within a shared channel occupancy time (COT) in accordance with one or more aspects of the present disclosure.

FIG. 2 shows an example of a wireless communication system that supports techniques for resuming sidelink transmissions within a shared COT in accordance with one or more aspects of the present disclosure.

FIG. 3 shows an example of a resource configuration that supports techniques for resuming sidelink transmissions within a shared COT in accordance with one or more aspects of the present disclosure.

FIG. 4 shows an example of a process flow that supports techniques for resuming sidelink transmissions within a shared COT in accordance with one or more aspects of the present disclosure.

FIGS. 5 and 6 show block diagrams of devices that support techniques for resuming sidelink transmissions within a shared COT in accordance with one or more aspects of the present disclosure.

FIG. 7 shows a block diagram of a communications manager that supports techniques for resuming sidelink transmissions within a shared COT in accordance with one or more aspects of the present disclosure.

FIG. 8 shows a diagram of a system including a device that supports techniques for resuming sidelink transmissions within a shared COT in accordance with one or more aspects of the present disclosure.

FIG. 9 shows a flowchart illustrating methods that support techniques for resuming sidelink transmissions within a shared COT in accordance with one or more aspects of the present disclosure.

### DETAILED DESCRIPTION

In some wireless communications systems, wireless devices may be able to communicate via licensed spectrum, unlicensed spectrum, or both. In the context of unlicensed spectrum, wireless devices may be configured to preform channel access procedures to gain access to channel occupancy times (COTs) within which the devices may perform communications. In some cases, wireless devices may be able to share access to COTs. For example, a first user equipment (UE) may successfully perform a channel access procedure to gain access to a COT, and may share the COT with a second UE. In this example, the first UE may transmit sidelink communications within the COT, and stop transmitting at some point so that the second UE may transmit within the COT. However, according to some conventional techniques, in order for the first UE to resume transmitting within the COT, the first UE may be expected to fully decode the messages received from the second UE, and perform a new channel access procedure before it may resume transmitting within the COT. The requirement to fully decode the messages and perform a new channel access procedure may result in increased latency for the first UE to resume communicating within the COT. Further, other wireless devices may successfully gain access to the COT before the first UE decodes the messages and successfully performs the channel access procedure, thereby causing the first UE to lose access to the COT.

Accordingly, aspects of the present disclosure are directed to techniques that enable wireless devices that reserve and share a COT (e.g., “reserving” devices) to validate received communications and efficiently resume transmissions within the COT. In particular, aspects of the present disclosure are directed to techniques that enable reserving UEs to share a COT with other devices, and to perform channel access procedures to resume transmissions within the COT without fully decoding messages received from other devices sharing the COT.

In some implementations, a first UE (e.g., “reserving” UE) may gain access to a COT, and share the COT with a second UE. The first/reserving UE may transmit messages within the COT, and may stop transmitting within the COT to allow the second UE to transmit messages within the COT. In this example, the first UE may be able to refrain from fully decoding messages received from the second UE within the COT (and go directly to performing a channel access procedure to resume transmitting within the COT) as long as the messages are “expected” messages. Additionally, or alternatively, the UE may begin a decoding procedure to decode the received message, but may begin (and/or complete) the channel access procedure before a completion of the decoding procedure (e.g., without fully decoding the message).

The term “expected” messages may refer to messages that are received within previously reserved or allocated resources. For example, an “expected” message may include a feedback message from the second UE that is responsive to a sidelink message that was previously transmitted by the first UE, where there is a relationship (e.g., a preconfigured relationship) between the resources used to transmit the sidelink message and receive the feedback message. By way of another example, an “expected” message may include a sidelink message that was previously scheduled by the second UE. In such cases, upon determining that a received message is an “expected” message (e.g., received on previously reserved or allocated resources), the first UE may jump directly to performing a channel access procedure to resume communicating on the COT, and without fully decoding the expected message.

Aspects of the disclosure are initially described in the context of wireless communications systems. Additional aspects of the disclosure are described in the context of an example resource configuration and an example process flow. Aspects of the disclosure are further illustrated by and described with reference to apparatus diagrams, system diagrams, and flowcharts that relate to techniques for resuming sidelink transmissions within a shared COT.

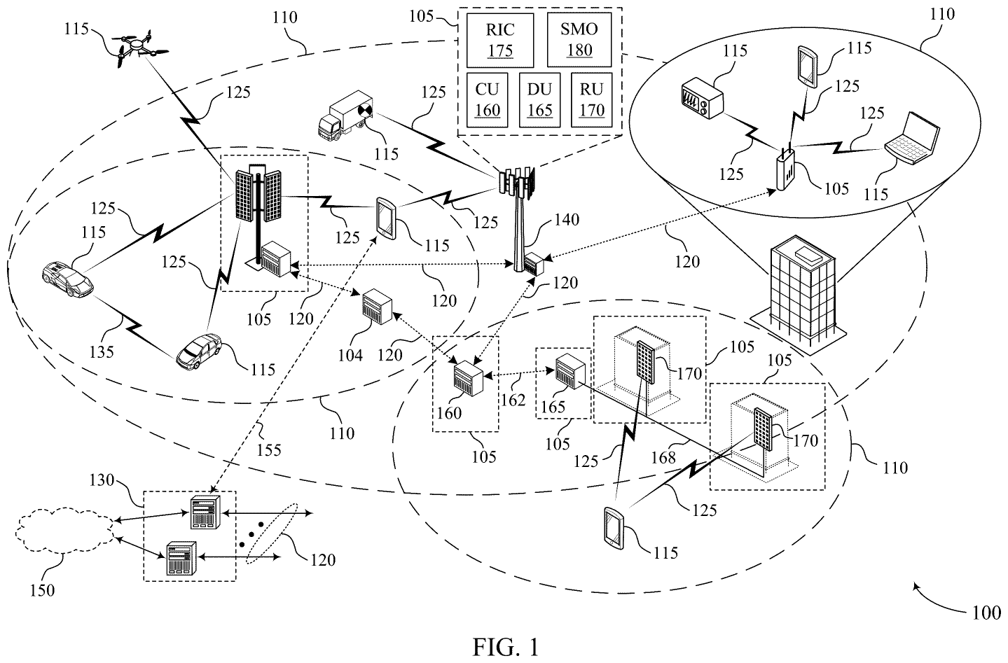

FIG. 1 shows an example of a wireless communications system 100 that supports techniques for resuming sidelink transmissions within a shared COT in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for resuming sidelink transmissions within a shared COT as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates the operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHZ.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless devices of the wireless communications system 200 may be configured to support techniques that enable wireless devices that reserve and share a COT (e.g., “reserving” devices) to validate received communications and efficiently resume transmissions within the COT. In particular, the wireless communications system 100 may support signaling, configurations, and techniques that enable reserving UEs 115 to share a COT with other devices, and to perform channel access procedures to resume transmissions within the COT without fully decoding messages received from other devices sharing the COT (e.g., begin the channel access procedure prior to a completion of a decoding process for the received message(s)).

For example, in some implementations, a first UE 115 within the wireless communications system 100 may perform a channel access procedure to gain access to a COT, and share the COT with a second UE 115. The first UE 115 may transmit messages within the COT, and may stop transmitting within the COT to allow the second UE 115 to transmit messages within the COT. In this example, the first UE 115 may be able to refrain from fully decoding messages received from the second UE 115 within the COT (and go directly to performing a channel access procedure to resume transmitting within the COT) as long as the messages are “expected” messages. Additionally, or alternatively, the UE 115 may begin a decoding procedure to decode the “expected” message(s), but may begin (and/or complete) the channel access procedure before a completion of the decoding procedure (e.g., without fully decoding the expected message(s)).

The term “expected” messages may refer to messages that are received within previously reserved or allocated resources. For example, an “expected” message may include a feedback message from the second UE 115 that is responsive to a sidelink message that was previously transmitted by the first UE 115, where there is a preconfigured relationship between the resources used to transmit the sidelink message and receive the feedback message. By way of another example, an “expected” message may include a sidelink message that was previously scheduled by the second UE 115. In such cases, upon determining that a received message is an “expected” message (e.g., received on previously reserved or allocated resources), the first UE 115 may jump directly to performing a channel access procedure to resume communicating on the COT, and without fully decoding the expected message.

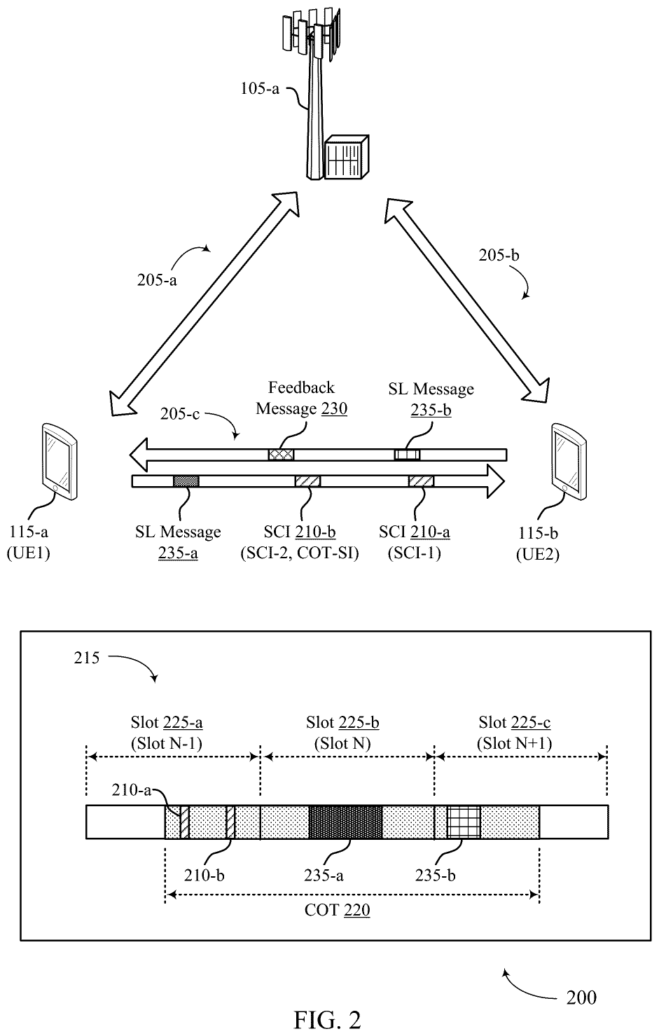

FIG. 2 shows an example of a wireless communications system 200 that supports techniques for resuming sidelink transmissions within a shared COT in accordance with one or more aspects of the present disclosure. Aspects of the wireless communications system 200 may implement, or be implemented by, aspects of the wireless communications system 100. For example, the wireless communications system 200 illustrates signaling between UEs 115 that enable the UEs 115 to share a COT, and that allow the reserving UE 115 to efficiently resume transmissions within the shared COT after receiving messages within the COT.

The wireless communications system 200 may include a first UE 115-a (UE1), a second UE 115-b (UE2), and a network entity 105-a, which may be examples of UEs 115, network entities 105, and other wireless devices as described with reference to FIG. 1. In some aspects, the first UE 115-a and the second UE 115-b may communicate with the network entity 105-a via a communication link 205-a and a communication link 205-b, respectively. In some cases, the communication links 205-a, 205-b may include examples of access links (e.g., Uu links). The communication links 205-a, 205-b may include bi-directional links that can include both uplink and downlink communication. For example, the first UE 115-a may transmit uplink transmissions, such as uplink control signals or uplink data signals, to the network entity 105-a using the communication link 205-a, and the network entity 105-a may transmit downlink transmissions, such as downlink control signals or downlink data signals, to the first UE 115-a using the communication link 205-a. Similarly, the first UE 115-a and the second UE 115-b may communicate with one another via a communication link 205-c, which may be an example of a PC5 link between the devices.

The respective devices of the wireless communications system 200 may be configured to communicate via resources within licensed spectrum, unlicensed spectrum, or both. For example, the UEs 115 may each be configured with a single sidelink BWP (SL-BWP), where the configured-activated SL-BWP may be associated with resources within a band of licensed spectrum or unlicensed spectrum.

In the context of unlicensed spectrum, the UEs 115, the network entity 105-a, or both, may be configured to perform a channel access procedure in which the respective device monitors and evaluates a channel or carrier associated with the unlicensed spectrum. For example, the first UE 115-a may monitor a set of resources 215 (e.g., sidelink channel) associated with unlicensed spectrum as part of a channel access procedure in an attempt to claim use of the channel. In some aspects, the device may monitor and evaluate sets of resources 215 (e.g., channel) as part of the channel access procedure in order to determine whether the channel is free to access. In some aspects, the first UE 115-a may determine the channel (e.g., set of resources 215) is free to access if, through the channel access procedure, the first UE 115-a determines that the channel is idle for a preconfigured duration of time (e.g., a preconfigured quantity of sensing slots). In one aspect, a channel may be determined to be free to access according to a first type of channel access procedure for NR-U (e.g., Type 1 channel access procedure, our countdown based listen-before-talk (LBT) procedure) if the channel is idle for a random quantity of sensing slots. In this example, the first UE 115-a may transmit and acquire the channel (e.g., acquire access to a COT 220 within the channel) after successfully completing the Type 1 channel access procedure with a random quantity of sensing slots.

In some aspects, a channel may be determined to be free to access according to additional types of channel access procedures (e.g., Type 2 channel access procedure, or “one shot” LBT) if the channel is idle for a certain fixed period of time, (e.g., 25 us for a Type 2A channel access procedure, 16 us for a Type 2B channel access procedure). In this example, the first UE 115-a may transmit and acquire the channel after successfully completing the Type 2A or 2B channel access procedures with the predefined quantities of sensing slots. Additionally, or alternatively, respective devices may not be required to perform a channel access procedure (e.g., perform channel access sensing) before transmission if a gap between two transmissions is less than a certain fixed period of time, (e.g., 16 μs) within a COT (e.g., Type 2C channel access procedure).

After successfully performing a channel access procedure, the first UE 115-a may be able to perform communications within a COT 220 within the channel. In other words, the first UE 115-a may reserve the set of time/frequency resources of the COT 220 within the channel (e.g., set of resources 215) after successfully performing the channel access procedure within the channel (e.g., within the set of resources 215).

In some cases, the first UE 115-a may be able to share use of the COT 220 with other devices, such as the second UE 115-b. COT sharing is an agreed mechanism for which a responder (e.g., second UE 115-b) can use Type 2 channel access (e.g., one-shot LBT) to respond to a COT-initiating UE 115 (e.g., first UE 115-a) that performed a Type 1 channel access (countdown based LBT). In order to share the COT 220, the COT-sharing UE 115 (e.g., second UE 115-b) may receive COT sharing information (COT-SI) from the UE 115 that reserved the COT 220.

For instance, as described previously herein, the first UE 115-a may successfully perform a Type 1 channel access procedure to secure use of the COT 220. In some cases, the COT 220 may span one or more transmission time intervals (TTIs), such as the first slot 225-a (e.g., slot n−1), a second slot 225-b (e.g., slot n), and a third slot 225-c (e.g., slot n+1). The first UE 115-a may transmit a first-stage sidelink control information (SCI) (SCI-1) message (e.g., SCI-1 210-a) to one or more additional UEs 115, such as the second UE 115-b. The SCI-1 210-a may be communicated via a physical sidelink control channel (PSCCH), and may reserve a set of resources within the channel that will be used to communicate a second-stage SCI message (e.g., SCI-2 210-b). In some aspects, the second-stage SCI (e.g., SCI-2 210-b) may include COT-SI, and may be communicated via the resources reserved via the first-stage SCI (e.g., SCI-1 210-a). In some cases, the second UE 115-b may transmit a feedback message 230 (e.g., via a physical sidelink feedback channel (PSFCH) in response to the SCI-2 210-b). After exchanging the COT-SI, the respective UEs 115 may be able to share the COT 220 and communicate (e.g., transmit) sidelink messages 235-a, 235-b within the COT 220.

In this regard, in some cases, wireless devices may be able to share access to COTs 220. For example, as described herein, the first UE 115-a may successfully perform a channel access procedure to gain access to the COT 220, and may transmit an SCI-2 210-b (e.g., second-stage SCI message) that includes COT-SI to the second UE 115-b in order to share the COT 220 with the second UE 115-b. In this example, the first UE 115-a may transmit sidelink messages 235-a within the COT 220, and stop transmitting at some point so that the second UE 115-b may transmit within the COT 220. However, according to some conventional techniques, in order for the first UE 115-a to resume transmitting within the COT 220, the first UE 115-a may be expected to fully decode the messages received from the second UE 115-b, and perform a new channel access procedure before it may resume transmitting within the COT 220. The requirement to fully decode the messages and perform a new channel access procedure may result in increased latency for the first UE 115-a to resume communicating within the COT 220. Further, other wireless devices (such as Wi-Fi devices) may successfully gain access to the COT 220 before the first UE 115-a decodes the messages and successfully performs the channel access procedure, thereby causing the first UE 115-a to lose access to the COT 220.

Accordingly, the devices of the wireless communications system 200 may be configured to support techniques that enable the first UE 115-a that reserves and shares the COT 220 to validate received communications and efficiently resume transmissions within the COT 220. In particular, the wireless communications system 200 may support signaling, configurations, and techniques that enable the first UE 115-a (e.g., reserving UE 115-a) to share the COT 220 with other devices (e.g., second UE 115-b), and to perform channel access procedures to resume transmissions within the COT 220 without fully decoding messages received from other devices sharing the COT 220 (such as communications from the second UE 115-b).

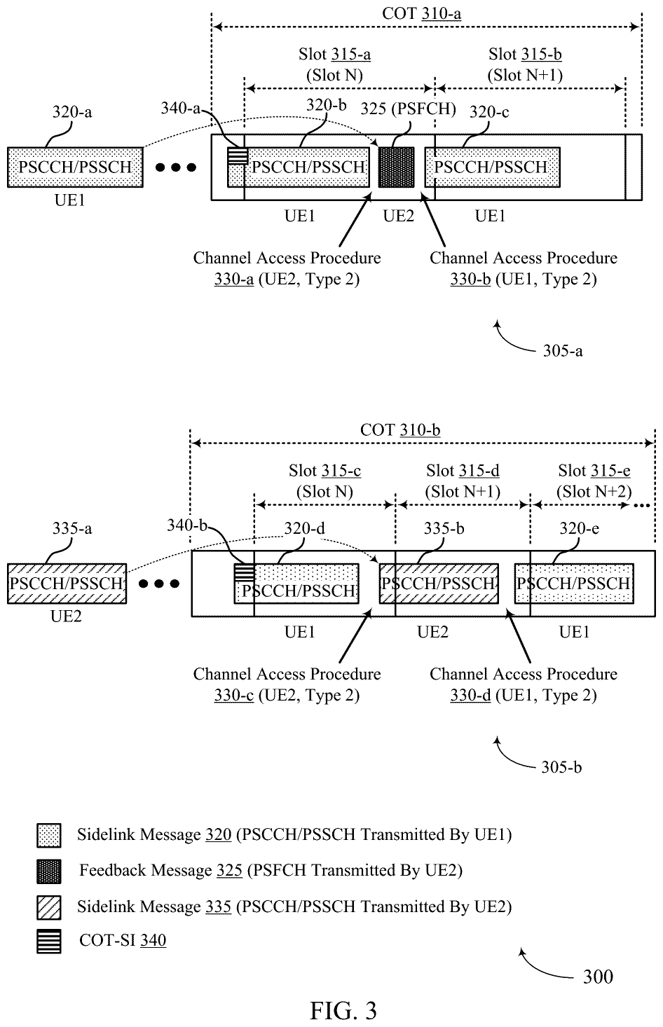

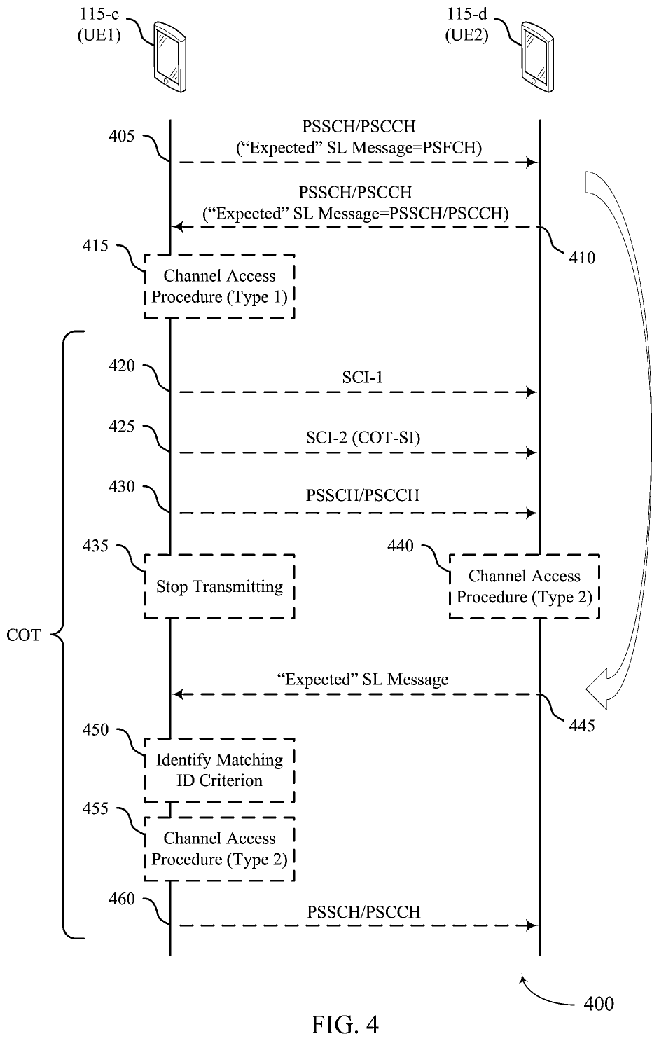

Shortfalls of conventional approaches for sharing COTs, as well as attendant advantages of the present disclosure, are further shown and described with reference to FIGS. 3 and 4.

FIG. 3 shows an example of a resource configuration 300 that supports techniques for resuming sidelink transmissions within a shared COT in accordance with one or more aspects of the present disclosure. Aspects of the resource configuration 300 may implement, or be implemented by, aspects of the wireless communications system 100, the wireless communications system 200, or both. In particular, the resource configuration 300 in FIG. 3 illustrates separate COT sharing configurations 305-a, 305-b that enable a reserving UE 115 (e.g., the first UE 115-a in FIG. 2) to share a COT 410 with another device (e.g., second UE 115-b in FIG. 2), and to efficiently resume transmitting within the COT 410.

Referring to the first COT sharing configuration 305-a, the first UE 115-a may perform a channel access procedure (e.g., Type 1 channel access procedure) within an unlicensed channel to gain access to a COT 310-a with the unlicensed channel. The COT 310-a may span one or more TTIs, such as a first slot 315-a and a second slot 315-b. The first UE 115-a may transmit second-stage SCI messages with COT-SI to other devices in order to share the COT 310-a with the other devices.

As described previously herein, the first UE 115-a may transmit within the COT 310-a, and may stop transmitting to allow other wireless devices with which the COT 310-a is shared to transmit within the COT 310-a. In some wireless communications systems, after receiving messages from other devices within the COT 310-a, the first UE 115-a may be able to resume its own transmissions within the COT 310-a after performing a Type 2 channel access procedure following the received messages. In some conventional systems, the first UE 115-a may be required (or expected) to fully decode the received messages before the first UE 115-a can perform the Type 2 channel access procedure, and resume transmitting within the COT 310-a.

For instance, continuing with reference to the first COT sharing configuration 305-a, the first UE 115-a may perform a transmission burst (e.g., multiple consecutive transmissions), such as the sidelink messages 320-a, 320-b, and 320-c illustrated within the COT 310-a. In cases where the first UE 115-a shares the COT 310-a with other devices, the first UE 115-a may stop transmitting the sidelink messages 320 to allow for other devices to transmit messages, such as the feedback message(s) 325 (e.g., sharing the COT 310-a for PSFCH slots). In this example, the first UE 115-a may want to resume transmitting within the COT 310-a after the incoming feedback message 325 (PSFCH) is received. In some conventional systems, the first UE 115-a may be required to fully decode (e.g., turn on the modem, buffer, and process/decode data, etc.) the feedback message(s) 325 and perform a Type 2 channel access procedure to resume transmitting within the COT 310-a. However, in some cases, there may not be sufficient time for the first UE 115-a to decode the feedback message(s) 325 (PSFCH) and successfully perform a Type 2 channel access procedure to resume transmissions within the COT 310-a. For instance, in some cases, the feedback message(s) 325 (PSFCH) may terminate in symbol #12, leaving only symbol #13 of slot 315-a for decoding and performing the Type 2 channel access procedure, which may be insufficient time for the first UE 115-a to complete prior to the end of the slot 315-a, which may result in other devices jumping in and gaining access of the COT 310-a.

Similar issues (e.g., insufficient time to fully decode received messages and perform Type 2 channel access) arise in the context of the second COT sharing configuration 305-b. For instance, referring to the second COT sharing configuration 305-b, the first UE 115-a receives sidelink messages 335-b from another device within a reserved COT 310-b that spans slots 315-c, 315-d, and 315-e, and does not have sufficient time to fully decode the sidelink messages 335-b and perform Type 2 channel access before an end of the slot 315-d to resume communications within the COT 310-b.

Accordingly, aspects of the present disclosure are directed to criterion for the COT-initiating UE 115 (e.g., first UE 115-a) to validate received transmissions (e.g., feedback message 325) without forcing a full decoding of the received transmission itself. Such techniques described herein can help tighten the use of reserved COTs 310, prevent other undesired devices (e.g., Wi-Fi devices) from jumping in and “stealing” the COT 310, and improve throughput of reserving devices.

Stated differently, aspects of the present disclosure are directed to techniques that enable wireless devices that reserve and share a COT 310 (e.g., “reserving” devices) to validate received communications (e.g., feedback message 325, sidelink message 335-b) and efficiently resume transmissions within the COT 310. Aspects of the present disclosure are directed to techniques that enable reserving UEs 115 to share a COT 310 with other devices, and to perform channel access procedures to resume transmissions within the COT 310 without fully decoding messages received from other devices sharing the COT 310.

In particular, aspects of the present disclosure may enable a reserving UE 115 to share a COT 310 with other devices, and to perform channel access procedures to resume transmissions within the COT 310 without fully decoding “expected” messages received from other devices sharing the COT 310. For the purposes of the present disclosure, the term “expected” messages may refer to messages that are received within previously reserved or allocated resources. For example, an “expected” message may include a feedback message (e.g., feedback message 325 in the first COT sharing configuration 305-a) from the second UE 115-b that is responsive to a sidelink message (e.g., sidelink message 320-a) that was previously transmitted by the first UE 115-a, where there is a preconfigured relationship between the resources used to transmit the sidelink message and receive the feedback message. By way of another example, an “expected” message may include a sidelink message (e.g., sidelink message 335-b in the second COT sharing configuration 305-b) that was previously scheduled by the second UE 115-b (e.g., via the sidelink message 335-a).

In such cases, upon determining that a received message is an “expected” message (e.g., received on previously reserved or allocated resources), the first UE 115-a may jump directly to performing a channel access procedure (assuming there is some minimum “gap” for the applicable channel access procedure following the expected message, such as 16 μs or 25 μs, as described previously herein) to resume communicating on the COT 310, and without fully decoding the “expected” message. In particular, the first UE 115-a may receive the expected message, but may not fully decode the expected message (because it was received on previously reserved/allocated resources) in that the first UE 115-a does not fully power on a modem to process and/or decode information/data included within the expected message. Rather, the first UE 115-a may simply receive the expected message and may identify the signal power/gain of the expected message within the expected resources, but may not fully process and decode the information within the expected message. In cases where the first UE 115-a does not decode the message before performing a channel access procedure, the first UE 115-a may rather buffer the message in memory so that the information/data included within the message may be processed/decoded at a later time.

Reference will be made to the first COT sharing configuration 305-a. In accordance with some aspects of the present disclosure, the COT-initiating UE 115 (e.g., first UE 115-a) that reserved the COT 310-a and transmitted COT-SI 340-a to share the COT 310-a can resume its transmissions within the COT 310-a after Type 2 channel access (e.g., channel access procedure 330-b) after stopping its transmissions to receive an “expected” PSFCH message. For instance, as shown in the first COT sharing configuration 305-a, the first UE 115-a may have previously transmitted a sidelink message 320-a (e.g., PSCCH, PSSCH), where the sidelink message 320-a is associated with resources that are allocated for a feedback message 325 (PSFCH) responsive to the sidelink message 320-a. That is, PSFCH resources are mapped to a PSSCH occasion. In this regard, after transmitting the sidelink message 320-a (e.g., PSSCH), the first UE 115-a will “expect” a feedback message 325 from the second UE 115-b on specific mapped resources (where the second UE 115-b may be required/expected to perform a Type 2 channel access procedure 330-a prior to transmitting the feedback message 325). As such, the feedback message 325 in the first COT sharing configuration 305-a may be “expected” due to the fact that the feedback message 325 is received on resources allocated/reserved for feedback responsive to the sidelink message 320-a. In this regard, because the feedback message 325 constitutes an “expected” message, the first UE 115-a may refrain from fully decoding the feedback message 325 and perform a channel access procedure 330-b (e.g., Type 2) after receiving the feedback message 325 to resume transmitting sidelink message(s) 320-c within the COT 310-a. As noted previously herein, the channel access procedure 330-b may be associated with different quantities of sensing symbols/slots (e.g., a “gap”), such as 25 μs for a Type 2A channel access procedure and 16 μs for a Type 2B channel access procedure.

In some cases, the feedback message 325 may qualify as an “expected” PSFCH (thereby allowing the first UE 115-a to refrain from decoding the feedback message 325) as long as the expected feedback message 325 (PSFCH) is received from a “responding” UE 115. In some cases, a UE 115 may qualify as a “responding” UE 115 if the other UE 115 received the COT-SI 340-a from the first UE 115-a. For example, after reserving the COT 310-a, the first UE 115-a may transmit COT-SI 340-a to the second UE 115-b within an SCI-2 or other sidelink message 320-b (PSSCH), thereby making the second UE 115-b a “responding” UE 115-b.

In some cases, the determination that the expected PSFCH (e.g., feedback message 325) is from a responding UE 115 is based on a matching identifier (ID) criterion. That is, the first UE 115-a may determine whether a matching ID criterion is satisfied in order to determine whether the feedback message 325 was received from a “responding” UE 115, thereby qualifying the feedback message 325 as an “expected” message. In some cases, the matching ID criterion may be satisfied if an identifier within the sidelink message 320-a (which is associated with the feedback message 325) matches an identifier within the COT-SI 340-a.

For instance, in some cases, the matching ID criterion may be satisfied (thereby qualifying the feedback message 325 as an “expected” message that enables the first UE 115-a to refrain from decoding the feedback message 325) as long as the PSFCH (e.g., feedback message 325) is in response to a previous PSSCH from the first UE 115-a (e.g., sidelink message 320-a) that carried SCI-2 logical IDs that are equal to logical IDs carried in SCI-2 that carried the COT-SI 340-a.

Reference will now be made to the second COT sharing configuration 305-b. The second COT sharing configuration 305-b illustrates signaling and configurations that enable a reserving UE 115 (e.g., first UE 115-a) to resume using a COT 310-b after a slot (e.g., slot 315-d) reserved for PSSCH from another UE 115 (e.g., second UE 115-b).

For example, in accordance with some aspects of the present disclosure, the COT-initiating UE 115 (e.g., first UE 115-a) that transmitted COT-SI 340-b to share the COT 310-b can resume its transmissions after Type 2 channel access (e.g., channel access procedure 330-d) after stopping its transmissions to receive an expected PSSCH (e.g., sidelink message 335-b). For instance, as shown in the second COT sharing configuration 305-b, the second UE 115-b may have previously transmitted a sidelink message 335-a (e.g., PSCCH, PSSCH), where the sidelink message 335-a schedules another sidelink message 335-b to be transmitted by the second UE 115-b (e.g., the sidelink message 335-a reserves resources for the sidelink message 335-b). In this regard, after receiving the sidelink message 335-a (e.g., PSSCH), the first UE 115-a will “expect” to receive the scheduled sidelink message 335-b on the reserved/allocated resources (where the second UE 115-b may be required/expected to perform a Type 2 channel access procedure 330-c prior to transmitting the sidelink message 335-b). As such, the sidelink message 335-b in the second COT sharing configuration 305-b may be “expected” due to the fact that it was previously scheduled by the second UE 115-b via the sidelink message 335-a. In this regard, because the sidelink message 335-b (e.g., PSSCH, PSCCH) constitutes an “expected” message, the first UE 115-a may refrain from fully decoding the sidelink message 335-b and perform a channel access procedure 330-d (e.g., Type 2) after receiving the sidelink message 335-b to resume transmitting sidelink message(s) 320-e within the COT 310-b.

In some aspects, the sidelink message 335-b may qualify as an “expected” message (thereby allowing the first UE 115-a to refrain from decoding the sidelink message 335-b) as long as the expected PSSCH (e.g., sidelink message 335-b) has been announced via resource reservation conveyed in SCI-1 by another UE 115. That is, as long as the second UE 115-b transmits an SCI-1 (e.g., sidelink message 335-a) that reserves/schedules the resources that are used to receive the sidelink message 335-b, the sidelink message 335-b may qualify as an “expected” message.

In some cases, the sidelink message 335-b may qualify as an “expected” PSFCH (thereby allowing the first UE 115-a to refrain from decoding the feedback message 325) as long as the expected sidelink message 335-b (PSSCH) is received from a “responding” UE 115. In some cases, a UE 115 may qualify as a “responding” UE 115 if the other UE 115 received the COT-SI 340-b from the first UE 115-a. For example, after reserving the COT 310-b, the first UE 115-a may transmit COT-SI 340-b to the second UE 115-b within an SCI-2 or other sidelink message 320-d (PSSCH), thereby making the second UE 115-b a “responding” UE 115-b.

In some other cases, the determination that the expected PSSCH (e.g., sidelink message 335-b) is from a responding UE 115 is based on a matching ID criterion, as described previously herein. That is, the first UE 115-a may determine whether a matching ID criterion is satisfied in order to determine whether the sidelink message 335-b was received from a “responding” UE 115, thereby qualifying the sidelink message 335-b as an “expected” message. In some cases, the matching ID criterion may be satisfied if an identifier within the sidelink message 335-a that scheduled the expected sidelink message 335-b matches an identifier within the COT-SI 340-b.

For instance, in some cases, the matching ID criterion may be satisfied (thereby qualifying the sidelink message 335-b as an “expected” message that enables the first UE 115-a to refrain from decoding the sidelink message 335-b) as long as the transmission containing the resource reservation from the second UE 115-b (e.g., sidelink message 335-a) carries one or more SCI-2 logical IDs that match logical IDs carried in SCI-2 of the transmission from the first UE 115-a that carried the COT-SI 340-b.

FIG. 4 shows an example of a process flow 400 that supports techniques for resuming sidelink transmissions within a shared COT in accordance with one or more aspects of the present disclosure. Aspects of the process flow 400 may implement, or be implemented by, aspects of the wireless communications system 100, the wireless communications system 200, the resource configuration 300, or any combination thereof. For example, the process flow 400 illustrates signaling between UEs 115 that enable the UEs 115 to share a COT, and that allow the reserving UE 115 to efficiently resume transmissions within the shared COT after receiving messages within the COT.

The process flow 400 includes a first UE 115-c and a second UE 115-d, which may be examples of UEs 115 and other wireless devices as described herein. For example, the first UE 115-c and the second UE 115-d illustrated in FIG. 4 may be examples of the first UE 115-a and the second UE 115-b, respectively, as illustrated in FIG. 2.

In some examples, the operations illustrated in process flow 400 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 405, the first UE 115-c may transmit a sidelink message (e.g., PSSCH/PSCCH) to the second UE 115-d. For example, as shown in the first COT sharing configuration 305-a in FIG. 3, the first UE 115-c may transmit a sidelink message 320-a to the second UE 115-d. As described previously herein, PSFCH resources may be mapped to PSSCH occasions. That is, the sidelink message at 405 may be associated with a set of resources that are allocated/reserved for a feedback message (e.g., feedback message 325). In this regard, as will be described in further detail herein, in cases where the first UE 115-c transmits the sidelink message at 405, the “expected” message at step 445 may include a feedback message (PSFCH) responsive to the sidelink message, and that is received on PSFCH resources mapped to the sidelink message at 405.

At 410, the first UE 115-c may receive a sidelink message (e.g., PSSCH/PSCCH) from the second UE 115-d. For example, as shown in the second COT sharing configuration 305-b in FIG. 3, the first UE 115-c may receive a sidelink message 335-a (PSCCH) from the second UE 115-d, where the sidelink message 335-a schedules another sidelink message 335-b (PSSCH) to be transmitted by the second UE 115-d. In other words, the sidelink message at 410 may schedule a sidelink message at 445. In this regard, as will be described in further detail herein, in cases where the first UE 115-c receives the sidelink message at 410, the “expected” message at step 445 may include another sidelink message (PSSCH) that was scheduled by the sidelink message at 410.

At 415, the first UE 115-c may perform a channel access procedure within a sidelink channel in order to gain access to a COT within the sidelink channel. In some cases, the channel access procedure at 415 may include a Type 1 channel access procedure.

At 420, the first UE 115-c may transmit a first-stage SCI message (SCI-1). In some cases, the SCI-1 may schedule an SCI-2 message (e.g., reserve resources for the SCI-2). The SCI-1 message may be communicated via a PSCCH. In some cases, the first UE 115-c may transmit the SCI-1 based on performing the channel access procedure at 415.

At 425, the first UE 115-c may transmit a second-stage SCI message (SCI-2). In some cases, the SCI-2 message may be transmitted within the resources reserved via the SCI-1 message at 420. The SCI-2 message may be communicated via a PSSCH. In some aspects, the SCI-2 message may include COT-SI (e.g., COT-SI 340 in FIG. 3) that includes information for sharing the COT with other devices. In some cases, the first UE 115-c may transmit the SCI-2 based on performing the channel access procedure at 415, transmitting the SCI-1 at 420, or both.

At 430, the first UE 115-c may transmit one or more sidelink messages (e.g., PSSCH/PSCCH) within the COT. For example, as shown in the first COT sharing configuration 305-a in FIG. 3, the first UE 115-c may transmit sidelink message(s) 320-b to the second UE 115-d. In some cases, as shown in FIG. 3, the sidelink message(s) 320-b may include the COT-SI 340-a. That is, in some cases, the SCI-2 carrying the COT-SI at 425 may be multiplexed with the sidelink message(s) at 430.

At 435, the first UE 115-c may stop transmitting within the COT. In particular, the first UE 115-c may stop transmitting within the COT based on identifying “expected” resources that are reserved or otherwise allocated for transmissions by another device (e.g., second UE 115-d) sharing the COT. As such, the first UE 115-c may stop transmitting at 435 in order to monitor the resources that are reserved/allocated for an “expected” message.

At 440, the second UE 115-d may perform a channel access procedure within the sidelink channel in order to gain access to the COT that was previously reserved by the first UE 115-c. In some cases, the channel access procedure at 440 may include a Type 2 channel access procedure.

At 445, the first UE 115 115-c may receive an “expected” message. As described previously herein, a message received at 445 may qualify as an “expected” message if the message is received within resources that were previously reserved or allocated for a message. For example, in cases where the first UE 115-c transmits the sidelink message at 405, the “expected” message at step 445 may include a feedback message (PSFCH) responsive to the sidelink message, where the feedback message at 445 is received on PSFCH resources mapped to the sidelink message at 405. By way of another example, in cases where the first UE 115-c receives the sidelink message at 410, the “expected” message at step 445 may include another sidelink message (PSSCH) that was scheduled by the sidelink message at 410.

As described with reference to FIG. 3, there may be other conditions or criteria that may be satisfied in order for a message received at 445 to qualify as an “expected” message. For example, in some cases, a message received at 445 may qualify as an “expected” message as long as the message is received from a “responding” UE (e.g., a UE 115 that received COT-SI from the first UE 115-c). In other case, a message received at 445 may qualify as an “expected” message as long as a matching ID criterion is satisfied. In such cases, the process flow 400 may proceed to step 450.

At 450, the first UE 115-c may evaluate whether a matching ID criterion is satisfied. As described previously herein, a message received at 445 may be received from a “responding” UE (thereby qualifying the message at 445 as an “expected” message and allowing the first UE 115-c to refrain from decoding the message at 445) as long as the matching ID criterion is satisfied.

For example, in some cases, the matching ID criterion may be satisfied if an identifier within the sidelink message at 405 (which is associated with the feedback message received at 445) matches an identifier within the COT-SI transmitted via the SCI-2 at 425. By way of another example, the matching ID criterion may be satisfied if an identifier within the sidelink message at 410 that scheduled the sidelink message at 445 matches an identifier within the COT-SI transmitted via the SCI-2 at 425.

In cases where the message received at 445 qualifies as an “expected” message, and/or in cases where the matching ID criterion is satisfied at 450, the first UE 115-c may be able to refrain from decoding the received message and go directly to a Type 2 channel access procedure in order to resume using the COT. As noted previously herein, the first UE 115-c may refrain from decoding the message received at 445 by not fully powering on a modem and/or refraining from processing and/or decoding information/data included within the message at 445. In cases where the first UE 115-c does not decode the message at 445 before performing a channel access procedure, the first UE 115-c may rather buffer the message in memory so that the information/data included within the message may be processed/decoded at a later time (e.g., after completion of the channel access procedure and re-gaining access to the COT).

At 455, the first UE 115-c may perform a channel access procedure within the sidelink channel in order to re-gain access to the COT following receipt of the message at 445. In some cases, the channel access procedure at 455 may include a Type 2 channel access procedure.

At 460, the first UE 115-c may resume transmitting one or more sidelink messages (e.g., PSSCH/PSCCH) within the COT. The first UE 115-c may resume transmitting messages within the COT at 460 based on determining that the message received at 445 is an “expected” message (e.g., received on reserved/allocated resources), based on identifying the satisfaction of the matching ID criterions at 450, based on successfully completing the channel access procedure at 455, or any combination thereof.

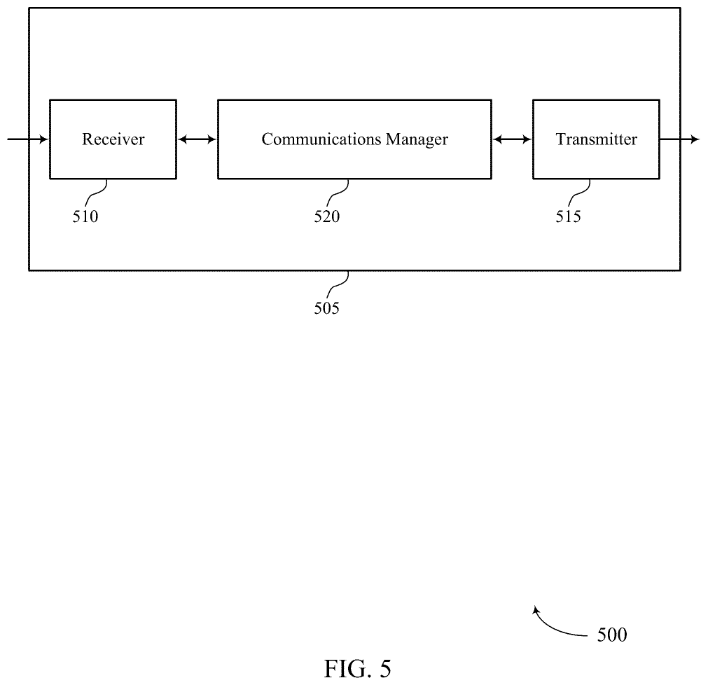

FIG. 5 shows a block diagram 500 of a device 505 that supports techniques for resuming sidelink transmissions within a shared COT in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The communications manager 520, the receiver 510, the transmitter 515, or various combinations thereof or various components thereof may be examples of means for performing various aspects of techniques for resuming sidelink transmissions within a shared COT as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

For example, the communications manager 520 is capable of, configured to, or operable to support a means for monitoring a sidelink channel as part of a first channel access procedure for accessing a COT within the sidelink channel. The communications manager 520 is capable of, configured to, or operable to support a means for transmitting a second-stage SCI message including COT-SI for sharing the COT with one or more additional UEs. The communications manager 520 is capable of, configured to, or operable to support a means for transmitting a first sidelink message within a first portion of the COT. The communications manager 520 is capable of, configured to, or operable to support a means for receiving a second sidelink message within a second portion of the COT based on transmitting the second-stage SCI message. The communications manager 520 is capable of, configured to, or operable to support a means for performing a second channel access procedure for accessing the COT and without decoding the second sidelink message based on the second sidelink message being received within a set of resources of the sidelink channel reserved for the second sidelink message. The communications manager 520 is capable of, configured to, or operable to support a means for transmitting a third sidelink message within a third portion of the COT based on a completion of the second channel access procedure.

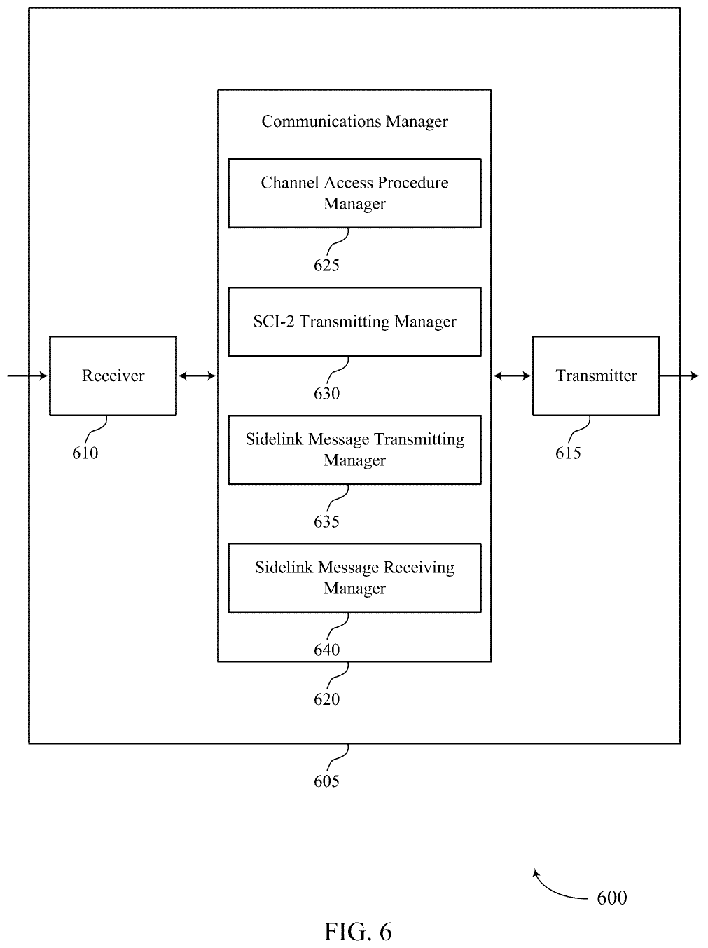

FIG. 6 shows a block diagram 600 of a device 605 that supports techniques for resuming sidelink transmissions within a shared COT in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The device 605, or various components thereof, may be an example of means for performing various aspects of techniques for resuming sidelink transmissions within a shared COT as described herein. For example, the communications manager 620 may include a channel access procedure manager 625, an SCI-2 transmitting manager 630, a sidelink message transmitting manager 635, a sidelink message receiving manager 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The channel access procedure manager 625 is capable of, configured to, or operable to support a means for monitoring a sidelink channel as part of a first channel access procedure for accessing a COT within the sidelink channel. The SCI-2 transmitting manager 630 is capable of, configured to, or operable to support a means for transmitting a second-stage SCI message including COT-SI for sharing the COT with one or more additional UEs. The sidelink message transmitting manager 635 is capable of, configured to, or operable to support a means for transmitting a first sidelink message within a first portion of the COT. The sidelink message receiving manager 640 is capable of, configured to, or operable to support a means for receiving a second sidelink message within a second portion of the COT based on transmitting the second-stage SCI message. The channel access procedure manager 625 is capable of, configured to, or operable to support a means for performing a second channel access procedure for accessing the COT and without decoding the second sidelink message based on the second sidelink message being received within a set of resources of the sidelink channel reserved for the second sidelink message. The sidelink message transmitting manager 635 is capable of, configured to, or operable to support a means for transmitting a third sidelink message within a third portion of the COT based on a completion of the second channel access procedure.

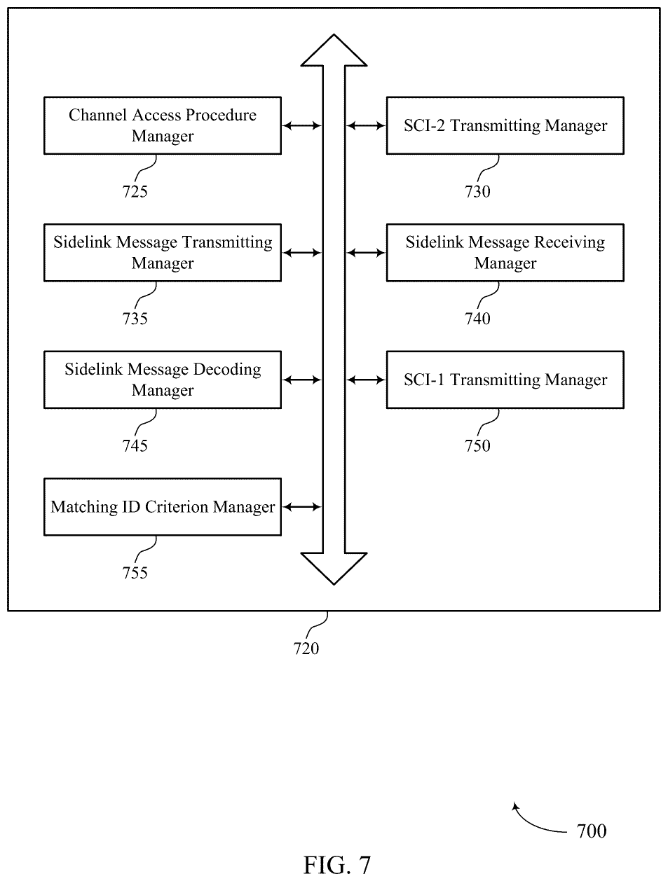

FIG. 7 shows a block diagram 700 of a communications manager 720 that supports techniques for resuming sidelink transmissions within a shared COT in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for resuming sidelink transmissions within a shared COT as described herein. For example, the communications manager 720 may include a channel access procedure manager 725, an SCI-2 transmitting manager 730, a sidelink message transmitting manager 735, a sidelink message receiving manager 740, a sidelink message decoding manager 745, an SCI-1 transmitting manager 750, a matching ID criterion manager 755, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The channel access procedure manager 725 is capable of, configured to, or operable to support a means for monitoring a sidelink channel as part of a first channel access procedure for accessing a COT within the sidelink channel. The SCI-2 transmitting manager 730 is capable of, configured to, or operable to support a means for transmitting a second-stage SCI message including COT-SI for sharing the COT with one or more additional UEs. The sidelink message transmitting manager 735 is capable of, configured to, or operable to support a means for transmitting a first sidelink message within a first portion of the COT. The sidelink message receiving manager 740 is capable of, configured to, or operable to support a means for receiving a second sidelink message within a second portion of the COT based on transmitting the second-stage SCI message. In some examples, the channel access procedure manager 725 is capable of, configured to, or operable to support a means for performing a second channel access procedure for accessing the COT and without decoding the second sidelink message based on the second sidelink message being received within a set of resources of the sidelink channel reserved for the second sidelink message. In some examples, the sidelink message transmitting manager 735 is capable of, configured to, or operable to support a means for transmitting a third sidelink message within a third portion of the COT based on a completion of the second channel access procedure.

In some examples, the sidelink message transmitting manager 735 is capable of, configured to, or operable to support a means for transmitting a fourth sidelink message to a second UE, where the set of resources are reserved for a feedback message responsive to the fourth sidelink message, the second sidelink message including the feedback message, and where the second channel access procedure is performed without decoding the second sidelink message based on the feedback message being received within the set of resources reserved for the feedback message.

In some examples, the SCI-2 transmitting manager 730 is capable of, configured to, or operable to support a means for transmitting the second-stage SCI message including the COT-SI to the second UE, where the second channel access procedure is performed without decoding the second sidelink message based on transmitting the COT-SI to the second UE and receiving the feedback message from the second UE.

In some examples, the matching ID criterion manager 755 is capable of, configured to, or operable to support a means for identifying a satisfaction of a matching identifier criterion based on a first identifier within the fourth sidelink message matching a second identifier within the COT-SI, where the second channel access procedure is performed without decoding the second sidelink message based on the satisfaction of the matching identifier criterion.

In some examples, the first identifier and the second identifier include logical identifiers associated with the second-stage SCI message.

In some examples, the feedback message is received via a PSSCH.

In some examples, the sidelink message receiving manager 740 is capable of, configured to, or operable to support a means for receiving a fourth sidelink message from a second UE, where the fourth sidelink message reserves the set of resources for the second sidelink message, and where the second channel access procedure is performed without decoding the second sidelink message based on the second sidelink message being received within the set of resources reserved by the fourth sidelink message.

In some examples, the fourth sidelink message includes a first-stage SCI message.

In some examples, the SCI-2 transmitting manager 730 is capable of, configured to, or operable to support a means for transmitting the second-stage SCI message including the COT-SI to the second UE, where the second channel access procedure is performed without decoding the second sidelink message based on transmitting the COT-SI to the second UE and receiving the second sidelink message from the second UE.

In some examples, the matching ID criterion manager 755 is capable of, configured to, or operable to support a means for identifying a satisfaction of a matching identifier criterion based on a first identifier within the fourth sidelink message matching a second identifier within the COT-SI, where the second channel access procedure is performed without decoding the second sidelink message based on the satisfaction of the matching identifier criterion.

In some examples, the first identifier and the second identifier include logical identifiers associated with the second-stage SCI message.

In some examples, the second sidelink message includes a sidelink shared channel message or a sidelink control channel message.

In some examples, the sidelink message transmitting manager 735 is capable of, configured to, or operable to support a means for refraining from transmitting sidelink messages within the second portion of the COT based on the set of resources of the sidelink channel being reserved for the second sidelink message within the second portion of the COT, where the second sidelink message is received based on refraining from transmitting sidelink messages within the second portion of the COT.

In some examples, the sidelink message decoding manager 745 is capable of, configured to, or operable to support a means for refraining from processing information included within the second-stage SCI message based on the second sidelink message being received within the set of resources reserved for the second sidelink message.

In some examples, the SCI-1 transmitting manager 750 is capable of, configured to, or operable to support a means for transmitting, based on a completion of the first channel access procedure, a first-stage SCI message that reserves a set of resources for the second-stage SCI message, where the second-stage SCI message is transmitted within the set of resources.

In some examples, the first channel access procedure includes a Type 1 channel access procedure. In some examples, the second channel access procedure includes a Type 2 channel access procedure.

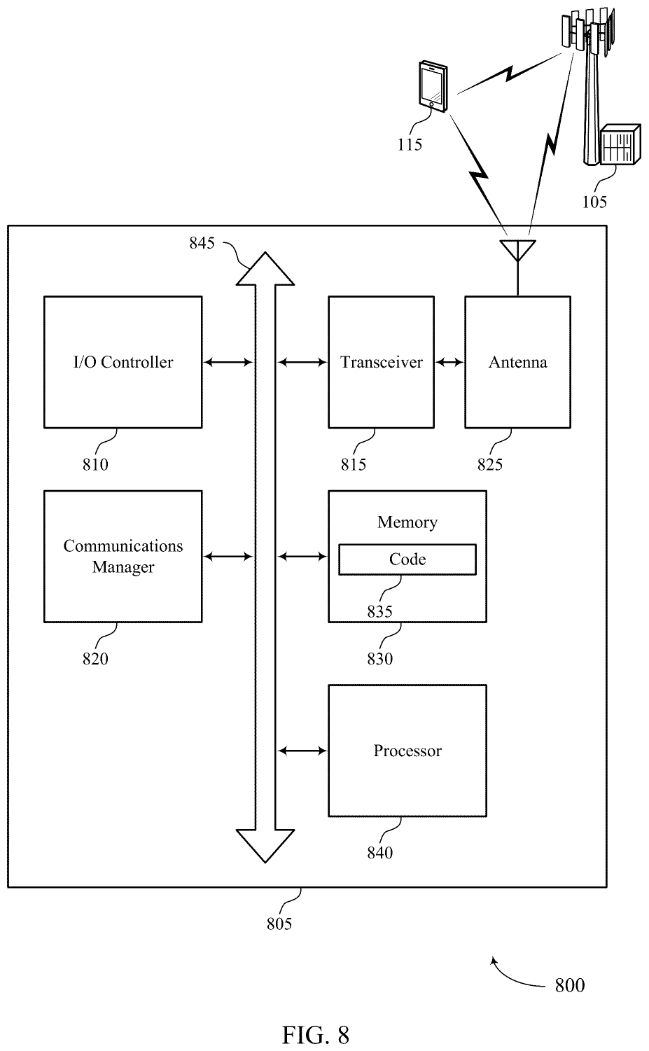

FIG. 8 shows a diagram of a system 800 including a device 805 that supports techniques for resuming sidelink transmissions within a shared channel occupancy time in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a basic I/O system (BIOS) which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting techniques for resuming sidelink transmissions within a shared channel occupancy time). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. As such, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 830 or otherwise, to perform one or more of the functions described herein.

For example, the communications manager 820 is capable of, configured to, or operable to support a means for monitoring a sidelink channel as part of a first channel access procedure for accessing a channel occupancy time (COT) within the sidelink channel. The communications manager 820 is capable of, configured to, or operable to support a means for transmitting a second-stage sidelink control information message including COT sharing information for sharing the COT with one or more additional UEs. The communications manager 820 is capable of, configured to, or operable to support a means for transmitting a first sidelink message within a first portion of the COT. The communications manager 820 is capable of, configured to, or operable to support a means for receiving a second sidelink message within a second portion of the COT based on transmitting the second-stage sidelink control information message. The communications manager 820 is capable of, configured to, or operable to support a means for performing a second channel access procedure for accessing the COT and without decoding the second sidelink message based on the second sidelink message being received within a set of resources of the sidelink channel reserved for the second sidelink message. The communications manager 820 is capable of, configured to, or operable to support a means for transmitting a third sidelink message within a third portion of the COT based on a completion of the second channel access procedure.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of techniques for resuming sidelink transmissions within a shared channel occupancy time as described herein, or the at least one processor 840 and the at least one memory 830 may be otherwise configured to, individually or collectively, perform or support such operations.

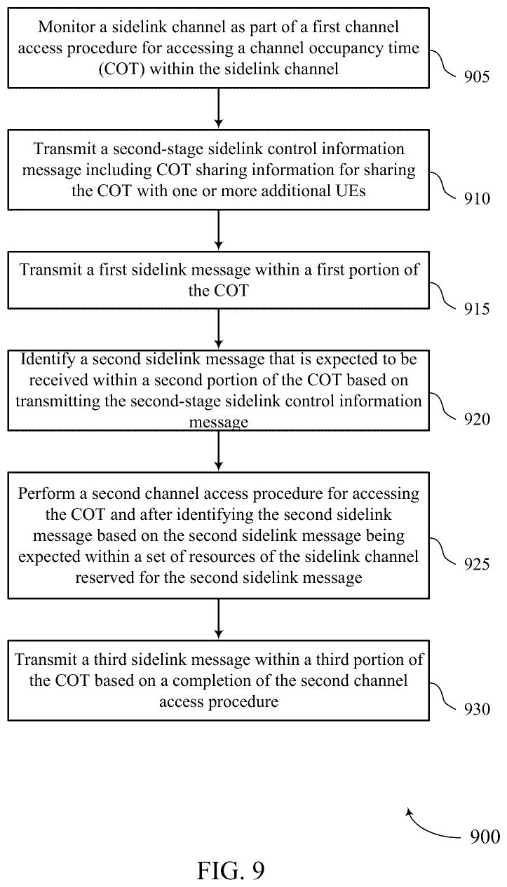

FIG. 9 shows a flowchart illustrating a method 900 that supports techniques for resuming sidelink transmissions within a shared COT in accordance with aspects of the present disclosure. The operations of the method 900 may be implemented by a UE 115 or its components as described herein. For example, the operations of the method 900 may be performed by a UE 115 as described with reference to FIGS. 1 through 7. In some examples, a UE 115 may execute a set of instructions to control the functional elements of the UE 115 to perform the described functions. Additionally, or alternatively, the UE 115 may perform aspects of the described functions using special-purpose hardware.

At 905, the method may include monitoring a sidelink channel as part of a first channel access procedure for accessing a COT within the sidelink channel. The operations of block 905 may be performed in accordance with examples as disclosed herein. In some examples, aspects of the operations of 905 may be performed by a channel access procedure manager 725 as described with reference to FIG. 7.

At 910, the method may include transmitting a second-stage SCI message including COT-SI for sharing the COT with one or more additional UEs. The operations of block 910 may be performed in accordance with examples as disclosed herein. In some examples, aspects of the operations of 910 may be performed by an SCI-2 transmitting manager 730 as described with reference to FIG. 7.

At 915, the method may include transmitting a first sidelink message within a first portion of the COT. The operations of block 915 may be performed in accordance with examples as disclosed herein. In some examples, aspects of the operations of 915 may be performed by a sidelink message transmitting manager 735 as described with reference to FIG. 7.

At 920, the method may include identifying a second sidelink message that is expected to be received within a second portion of the COT based on transmitting the second-stage SCI message. The operations of block 920 may be performed in accordance with examples as disclosed herein. In some examples, aspects of the operations of 920 may be performed by a sidelink message receiving manager 740 as described with reference to FIG. 7.

At 925, the method may include performing a second channel access procedure for accessing the COT and after identifying the second sidelink message based on the second sidelink message being expected within a set of resources of the sidelink channel reserved for the second sidelink message. The operations of block 925 may be performed in accordance with examples as disclosed herein. In some examples, aspects of the operations of 925 may be performed by a channel access procedure manager 725 as described with reference to FIG. 7.

At 930, the method may include transmitting a third sidelink message within a third portion of the COT based on a completion of the second channel access procedure. The operations of block 930 may be performed in accordance with examples as disclosed herein. In some examples, aspects of the operations of 930 may be performed by a sidelink message transmitting manager 735 as described with reference to FIG. 7.

The following provides an overview of aspects of the present disclosure:

Aspect 1: A method for wireless communications at a first UE, comprising: monitoring a sidelink channel as part of a first channel access procedure for accessing a COT within the sidelink channel; transmitting a second-stage SCI message comprising COT-SI for sharing the COT with one or more additional UEs; transmitting a first sidelink message within a first portion of the COT; identifying a second sidelink message that is expected to be received within a second portion of the COT based at least in part on transmitting the second-stage SCI message; performing a second channel access procedure for accessing the COT after identifying the second sidelink message based at least in part on the second sidelink message being expected within a set of resources of the sidelink channel reserved for the second sidelink message; and transmitting a third sidelink message within a third portion of the COT based at least in part on a completion of the second channel access procedure.

Aspect 2: The method of aspect 1, further comprising: transmitting a fourth sidelink message to a second UE, wherein the set of resources are reserved for a feedback message responsive to the fourth sidelink message, the second sidelink message comprising the feedback message, and wherein the second channel access procedure is performed after identifying the second sidelink message based at least in part on the feedback message being expected within the set of resources reserved for the feedback message.

Aspect 3: The method of aspect 2, wherein the second-stage SCI message comprising the COT-SI is transmitted to the second UE, the second channel access procedure is performed after identifying the second sidelink message based at least in part on transmitting the COT-SI to the second UE and identifying the feedback message from the second UE.

Aspect 4: The method of aspect 3, further comprising: identifying a satisfaction of a matching identifier criterion based at least in part on a first identifier within the fourth sidelink message matching a second identifier within the COT-SI, wherein the second channel access procedure is performed after identifying the second sidelink message based at least in part on the satisfaction of the matching identifier criterion.

Aspect 5: The method of aspect 4, wherein the first identifier and the second identifier comprise logical identifiers associated with the second-stage SCI message.

Aspect 6: The method of any of aspects 1 through 5, further comprising: receiving a fourth sidelink message from a second UE, wherein the fourth sidelink message reserves the set of resources for the second sidelink message, and wherein the second channel access procedure is performed after identifying the second sidelink message based at least in part on the second sidelink message being expected within the set of resources reserved by the fourth sidelink message.

Aspect 7: The method of aspect 6, wherein the fourth sidelink message comprises a first-stage SCI message.

Aspect 8: The method of any of aspects 6 through 7, wherein the second-stage SCI message comprising the COT-SI is transmitted to the second UE, the second channel access procedure is performed after identifying the second sidelink message based at least in part on transmitting the COT-SI to the second UE and identifying the second sidelink message from the second UE.

Aspect 9: The method of any of aspects 6 through 8, further comprising: identifying a satisfaction of a matching identifier criterion based at least in part on a first identifier within the fourth sidelink message matching a second identifier within the COT-SI, wherein the second channel access procedure is performed after identifying the second sidelink message based at least in part on the satisfaction of the matching identifier criterion.

Aspect 10: The method of aspect 9, wherein the first identifier and the second identifier comprise logical identifiers associated with the second-stage SCI message.

Aspect 11: The method of any of aspects 6 through 10, wherein the second sidelink message comprises a sidelink shared channel message and a sidelink control channel message.

Aspect 12: The method of any of aspects 1 through 11, further comprising: refraining from transmitting sidelink messages within the second portion of the COT based at least in part on the set of resources of the sidelink channel being reserved for the second sidelink message within the second portion of the COT, wherein the second sidelink message is received based at least in part on refraining from transmitting sidelink messages within the second portion of the COT.

Aspect 13: The method of any of aspects 1 through 12, further comprising: refraining from processing information included within the second-stage SCI message based at least in part on the second sidelink message being received within the set of resources reserved for the second sidelink message.

Aspect 14: The method of any of aspects 1 through 13, wherein identifying the second sidelink message comprises receiving the second sidelink message, the method further comprising: initiating a decoding procedure for decoding information included within the second sidelink message based at least in part on receiving the second sidelink message, wherein the second channel access procedure is performed prior to a completion of the decoding procedure.

Aspect 15: The method of any of aspects 1 through 14, wherein the first channel access procedure comprises a Type 1 channel access procedure, and the second channel access procedure comprises a Type 2 channel access procedure.

Aspect 16: A first UE for wireless communications, comprising one or more memories storing processor-executable code, and one or more processors coupled with the one or more memories and individually or collectively operable to execute the code to cause the first UE to perform a method of any of aspects 1 through 15.

Aspect 17: A first UE for wireless communications, comprising at least one means for performing a method of any of aspects 1 through 15.

Aspect 18: A non-transitory computer-readable medium storing code for wireless communications, the code comprising instructions executable by a processor to perform a method of any of aspects 1 through 15.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first user equipment (UE), comprising:
one or more memories storing processor-executable code; and
one or more processors coupled with the one or more memories and individually or collectively operable to execute the code to cause the first UE to:
monitor a sidelink channel as part of a first channel access procedure for accessing a channel occupancy time (COT) within the sidelink channel;
transmit a second-stage sidelink control information message comprising COT sharing information for sharing the COT with one or more additional UEs;
transmit a first sidelink message within a first portion of the COT;
identify a second sidelink message that is expected to be received within a second portion of the COT based at least in part on transmitting the second-stage sidelink control information message;
perform a second channel access procedure for accessing the COT after identifying the second sidelink message based at least in part on the second sidelink message being expected within a set of resources of the sidelink channel reserved for the second sidelink message; and
transmit a third sidelink message within a third portion of the COT based at least in part on a completion of the second channel access procedure.

2. The first UE of claim 1, wherein the one or more processors are individually or collectively further operable to execute the code to cause the first UE to:
transmit a fourth sidelink message to a second UE, wherein the set of resources are reserved for a feedback message responsive to the fourth sidelink message, the second sidelink message comprising the feedback message, and wherein the second channel access procedure is performed after identifying the second sidelink message based at least in part on the feedback message being expected within the set of resources reserved for the feedback message.

3. The first UE of claim 2, wherein the second-stage sidelink control information message comprising the COT sharing information is transmitted to the second UE, wherein the second channel access procedure is performed after identifying the second sidelink message based at least in part on transmitting the COT sharing information to the second UE and identifying the feedback message from the second UE.

4. The first UE of claim 3, wherein the one or more processors are individually or collectively further operable to execute the code to cause the first UE to:
identify a satisfaction of a matching identifier criterion based at least in part on a first identifier within the fourth sidelink message matching a second identifier within the COT sharing information, wherein the second channel access procedure is performed after identifying the second sidelink message based at least in part on the satisfaction of the matching identifier criterion.

5. The first UE of claim 4, wherein the first identifier and the second identifier comprise logical identifiers associated with the second-stage sidelink control information message.

6. The first UE of claim 1, wherein the one or more processors are individually or collectively further operable to execute the code to cause the first UE to:
receive a fourth sidelink message from a second UE, wherein the fourth sidelink message reserves the set of resources for the second sidelink message, and wherein the second channel access procedure is performed after identifying the second sidelink message based at least in part on the second sidelink message being expected within the set of resources reserved by the fourth sidelink message.

7. The first UE of claim 6, wherein the fourth sidelink message comprises a first-stage sidelink control information message.

8. The first UE of claim 6, wherein the second-stage sidelink control information message comprising the COT sharing information is transmitted to the second UE, wherein the second channel access procedure is performed after identifying the second sidelink message based at least in part on transmitting the COT sharing information to the second UE and identifying the second sidelink message from the second UE.

9. The first UE of claim 6, wherein the one or more processors are individually or collectively further operable to execute the code to cause the first UE to:
identify a satisfaction of a matching identifier criterion based at least in part on a first identifier within the fourth sidelink message matching a second identifier within the COT sharing information, wherein the second channel access procedure is performed after identifying the second sidelink message based at least in part on the satisfaction of the matching identifier criterion.

10. The first UE of claim 9, wherein the first identifier and the second identifier comprise logical identifiers associated with the second-stage sidelink control information message.

11. The first UE of claim 6, wherein the second sidelink message comprises a sidelink shared channel message and a sidelink control channel message.

12. The first UE of claim 1, wherein the one or more processors are individually or collectively further operable to execute the code to cause the first UE to:
refrain from transmitting sidelink messages within the second portion of the COT based at least in part on the set of resources of the sidelink channel being reserved for the second sidelink message within the second portion of the COT, wherein the second sidelink message is received based at least in part on refraining from transmitting sidelink messages within the second portion of the COT.

13. The first UE of claim 1, wherein the one or more processors are individually or collectively further operable to execute the code to cause the first UE to:
refrain from processing information included within the second-stage sidelink control information message based at least in part on the second sidelink message being received within the set of resources reserved for the second sidelink message.

14. The first UE of claim 1, wherein identifying the second sidelink message comprises receiving the second sidelink message, wherein the one or more processors are individually or collectively further operable to execute the code to cause the first UE to:
initiate a decoding procedure for decoding information included within the second sidelink message based at least in part on receiving the second sidelink message, wherein the second channel access procedure is performed prior to a completion of the decoding procedure.

15. The first UE of claim 1, wherein the first channel access procedure comprises a Type 1 channel access procedure, and wherein the second channel access procedure comprises a Type 2 channel access procedure.

16. A method for wireless communications at a first user equipment (UE), comprising:
monitoring a sidelink channel as part of a first channel access procedure for accessing a channel occupancy time (COT) within the sidelink channel;
transmitting a second-stage sidelink control information message comprising COT sharing information for sharing the COT with one or more additional UEs;
transmitting a first sidelink message within a first portion of the COT;
identifying a second sidelink message that is expected to be received within a second portion of the COT based at least in part on transmitting the second-stage sidelink control information message;
performing a second channel access procedure for accessing the COT after identifying the second sidelink message based at least in part on the second sidelink message being expected within a set of resources of the sidelink channel reserved for the second sidelink message; and
transmitting a third sidelink message within a third portion of the COT based at least in part on a completion of the second channel access procedure.

17. The method of claim 16, further comprising:
transmitting a fourth sidelink message to a second UE, wherein the set of resources are reserved for a feedback message responsive to the fourth sidelink message, the second sidelink message comprising the feedback message, and wherein the second channel access procedure is performed after identifying the second sidelink message based at least in part on the feedback message being expected within the set of resources reserved for the feedback message.

18. The method of claim 17, wherein the second-stage sidelink control information message comprising the COT sharing information is transmitted to the second UE, and wherein the second channel access procedure is performed after identifying the second sidelink message based at least in part on transmitting the COT sharing information to the second UE and identifying the feedback message from the second UE.

19. The method of claim 18, further comprising:
identifying a satisfaction of a matching identifier criterion based at least in part on a first identifier within the fourth sidelink message matching a second identifier within the COT sharing information, wherein the second channel access procedure is performed after identifying the second sidelink message based at least in part on the satisfaction of the matching identifier criterion.

20. The method of claim 19, wherein the first identifier and the second identifier comprise logical identifiers associated with the second-stage sidelink control information message.

21. The method of claim 16, further comprising:
receiving a fourth sidelink message from a second UE, wherein the fourth sidelink message reserves the set of resources for the second sidelink message, and wherein the second channel access procedure is performed after identifying the second sidelink message based at least in part on the second sidelink message being expected within the set of resources reserved by the fourth sidelink message.

22. The method of claim 21, wherein the fourth sidelink message comprises a first-stage sidelink control information message.

23. The method of claim 21, wherein the second-stage sidelink control information message comprising the COT sharing information is transmitted to the second UE, and wherein the second channel access procedure is performed after identifying the second sidelink message based at least in part on transmitting the COT sharing information to the second UE and identifying the second sidelink message from the second UE.

24. The method of claim 21, further comprising:
identifying a satisfaction of a matching identifier criterion based at least in part on a first identifier within the fourth sidelink message matching a second identifier within the COT sharing information, wherein the second channel access procedure is performed after identifying the second sidelink message based at least in part on the satisfaction of the matching identifier criterion.

25. The method of claim 24, wherein the first identifier and the second identifier comprise logical identifiers associated with the second-stage sidelink control information message.

26. The method of claim 21, wherein the second sidelink message comprises a sidelink shared channel message and a sidelink control channel message.

27. The method of claim 16, further comprising:
refraining from transmitting sidelink messages within the second portion of the COT based at least in part on the set of resources of the sidelink channel being reserved for the second sidelink message within the second portion of the COT, wherein the second sidelink message is received based at least in part on refraining from transmitting sidelink messages within the second portion of the COT.

28. The method of claim 16, further comprising:
refraining from processing information included within the second-stage sidelink control information message based at least in part on the second sidelink message being received within the set of resources reserved for the second sidelink message.

29. The method of claim 16, wherein identifying the second sidelink message comprises receiving the second sidelink message, the method further comprising:
initiating a decoding procedure for decoding information included within the second sidelink message based at least in part on receiving the second sidelink message, wherein the second channel access procedure is performed prior to a completion of the decoding procedure.

30. A non-transitory computer-readable medium storing code for wireless communications, the code comprising instructions executable by one or more processors to:
monitor a sidelink channel as part of a first channel access procedure for accessing a channel occupancy time (COT) within the sidelink channel;
transmit a second-stage sidelink control information message comprising COT sharing information for sharing the COT with one or more additional UEs;
transmit a first sidelink message within a first portion of the COT;
identify a second sidelink message that is expected to be received within a second portion of the COT based at least in part on transmitting the second-stage sidelink control information message;
perform a second channel access procedure for accessing the COT after identifying the second sidelink message based at least in part on the second sidelink message being expected within a set of resources of the sidelink channel reserved for the second sidelink message; and
transmit a third sidelink message within a third portion of the COT based at least in part on a completion of the second channel access procedure.
